(19) United States
(12) Patent Application Publication
(10) Pub. No.: US 2026/0255467 A1
(43) Pub. Date: Aug. 27, 2026

(54) TUBULAR NON-THERMAL PLASMA GENERATOR

(71) Applicant: MagPlasma Inc., Brighton, MI (US)

(72) Inventors: Martin E. Toomajian, Brighton, MI (US); Kevin D. Hawley, Dexter, MI (US)

(21) Appl. No.: 19/395,335

(22) Filed: Nov. 20, 2025

Related U.S. Application Data
(60) Provisional application No. 63/762,276, filed on Feb. 24, 2025.

(51) Int. Cl. H05H 1/24

(52) U.S. Cl. CPC H05H 1/245

(57) ABSTRACT

A non-thermal plasma generator including at least one hollow tube being made of a dielectric material, at least one outer conductor positioned around and in contact with an outer surface of the at least one tube, and at least one inner conductor extending parallel to the at least one tube at a location so that at least some of the dielectric material is between the inner and outer conductors. A power source provides a power signal to the at least one inner and outer conductors so as to provide a plasma field within the at least one tube effective to remove contaminants in a gas within the at least one tube.

### CROSS-REFERENCE TO RELATED APPLICATIONS

This application claims the benefit of the priority date of U.S. Provisional Patent Application Serial No. 63/762,276, titled Tubular Non-Thermal Plasma Generator, filed February 24, 2025.

### BACKGROUND

### Field

This disclosure relates generally to a tubular non-thermal plasma generator and, more particularly, to a tubular non-thermal plasma generator including multiple groups of tubes.

### Discussion of the Related Art

Various contagions, such as viruses, are spread by infected individuals (asymptomatic and symptomatic) through particle release from respiration, coughing, sneezing and subsequent surface contamination and contact or inhalation by a person. A significant number of patients become seriously ill from the infection and require hospitalization, which increases the likelihood of exposure to healthcare workers and intra-hospital spread of the contagion. A smaller but still sizable number of patients require the use of assisted breathing support via a manual or automated ventilator system due to complications from pneumonia. The COVID-19 outbreak demonstrates how easily existing hospital intensive care units (ICUs) and isolation wards can become overwhelmed when contagion dosages become concentrated enough to overcome healthcare workers' personal protective equipment. Hospital, and other healthcare facilities become overwhelmed when the high volume and density of patients ensures that hospitals and other treatment locations become significantly loaded with viral particles that can remain airborne for hours before coming to rest on various surfaces, thus multiplying the potential for exposure of medical staff and other patients.

### SUMMARY

The following discussion discloses and describes a non-thermal plasma generator including at least one hollow tube being made of a dielectric material, at least one outer conductor positioned around and in contact with an outer surface of the at least one tube, and at least one inner conductor extending parallel to the at least one tube at a location so that at least some of the dielectric material is between the inner and outer conductors. A power source provides a power signal to the at least one inner and outer conductors so as to provide a plasma field within the at least one tube effective to destroy or deactivate contaminants in a gas within the at least one tube.

Additional features of the disclosure will become apparent from the following description and appended claims, taken in conjunction with the accompanying drawings.

### BRIEF DESCRIPTION OF THE DRAWINGS

FIG. 1 is an illustration of a tubular non-thermal plasma generator including a single tube;

FIG. 2 is an illustration of a tubular non-thermal plasma generator including a group of tubes with a conductor extending down each tube;

FIG. 3 is an illustration of a tubular non-thermal plasma generator including a central core and a group of tubes disposed around the core;

FIG. 4 is an isometric view of a tubular non-thermal plasma generator including an inner group of tubes and an outer conductor and an outer group of tubes disposed around the inner group of tubes and an outer conductor; and

FIG. 5 is an end view of the plasma generator shown in FIG. 4.

### DETAILED DESCRIPTION OF THE EMBODIMENTS

The following discussion of the embodiments of the disclosure directed to various embodiments of a tubular non-thermal plasma generator is merely exemplary in nature, and is in no way intended to limit the disclosure or its applications or uses.

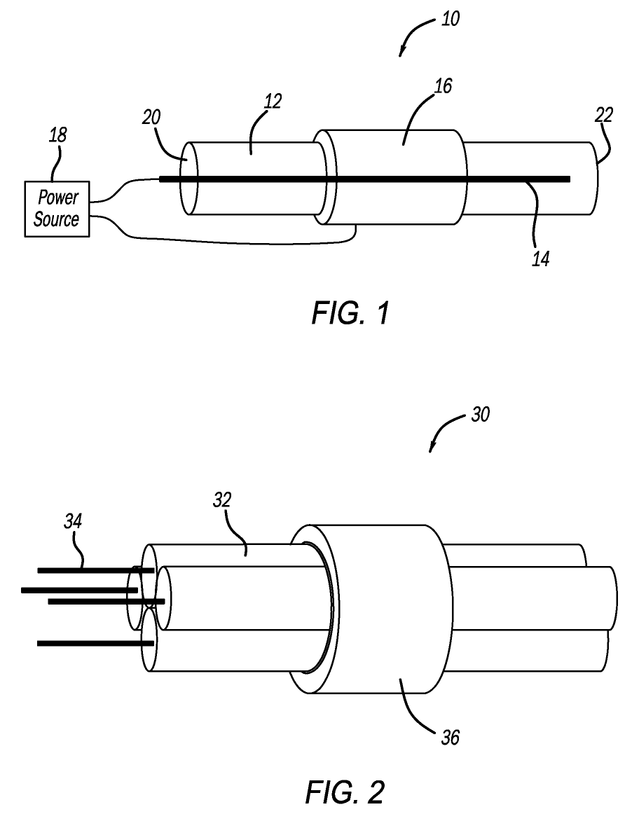

FIG. 1 is an illustration of a tubular non-thermal plasma generator 10 including a single dielectric tube 12, an inner conductor 14 extending down the tube 12 and an annular outer conductor 16 formed outside of, around and in contact with the tube 12. The tube 12 is made of a suitable dielectric for the purposes discussed herein, such as glass, and the conductors 12 and 16 are made of a suitable conductive material, such as copper or aluminum. In this non-limiting embodiment, the inner conductor 14 extends the complete length of the tube 12 and is centered within the tube 12, and the outer conductor 16 is centered along the tube 12 and only extends along a portion of the tube 12. However, in other embodiments, the inner conductor 14 may not be centered in the tube 12 and may only extend a portion of the distance down the tube 12, and the outer conductor 16 may be positioned at other locations along the tube 12, where a suitable amount of dielectric material is provided between the conductors 12 and 16. A power supply 18 provides power to the conductors 14 and 16 that creates a plasma field within the tube 12 because of the dielectric material of the tube 12 being between the conductors 14 and 16. The power supply 18 can provide AC power at a suitable frequency or DC power, where either conductor 14 and 16 can be at ground. In one non-limiting embodiment, the power supply 18 operates in the 5 kV - 30 kV range, and preferably in the 6 kV – 10 kV range, at a frequency in the 15 kHz – 25 kHz range. The tube 12 can have any diameter, such as 8-10 mm, suitable for the purposes discussed herein to be able to generate the desired intensity plasma field within the tube 12. The outer wall of the tube 12 can be any thickness suitable for the desired rigidity.

Air, or other gas, that may be contaminated with a pathogen, virus, or other contaminants from any suitable source is caused to flow down the tube 12 from an input end 20 to an output end 22 by, for example, a fan or other flow device (not shown) so that it interacts with the plasma field to destroy or deactivate the contaminants and purify the air. By providing a suitably intense plasma field and a suitable length of the tube 12, the contaminants in the air flow will be destroyed or deactivated so that clean air flow is provided at the output end 22 of the tube 12.

The strength of the plasma field provided to destroy or deactivate the contaminants in the air flow determines the volume of air and flow rate that can be sent down the tube 12. In order to increase the volume of air that can be treated, multiple tubes can be employed.

FIG. 2 is an illustration of a tubular non-thermal plasma generator 30 including a plurality of dielectric tubes 32. A separate inner conductor 34 extends down each tube 32, such as down a center of each tube 32, and a single annular outer conductor 36 is formed outside of, around and in contact with all of the tubes 32. A power signal from a power source, such as the power source 18, provides power to all of the conductors 34 and 36. Therefore, a strong plasma field can be provided in each of the tubes 32 and more air can be treated that flows within the tubes 32.

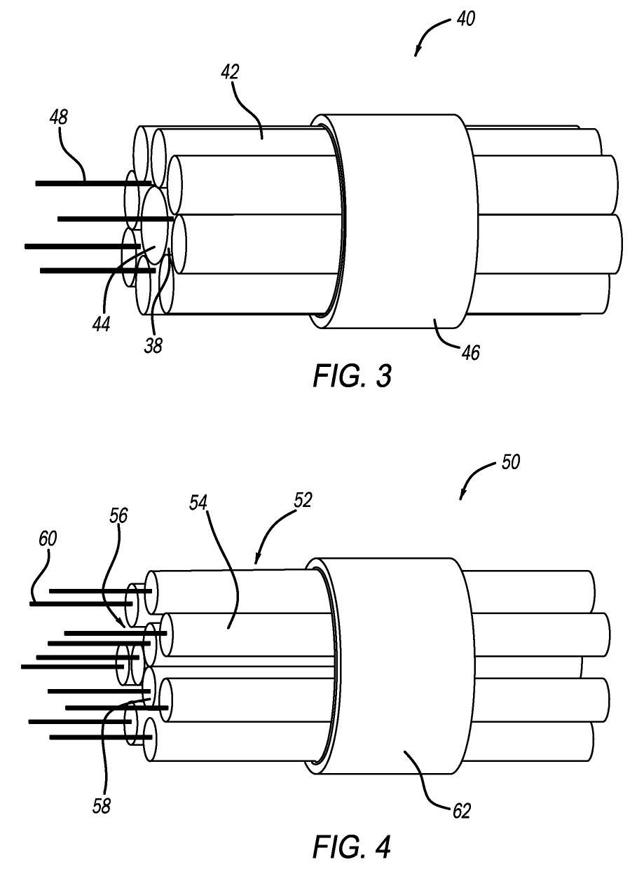

The conductors 34 extend within the tubes 32. In an alternate embodiment, the conductors can be placed between the tubes. FIG. 3 is an illustration of a tubular non-thermal plasma generator 40 showing this embodiment. The generator 40 includes a plurality of tubes 42, here eight, disposed around a central cylindrical solid dielectric core 44 that extends the length of the tubes 42 and a single annular outer conductor 46 is formed outside of, around and in contact with all of the tubes 42. A plurality of inner conductors 48 extend down the length of the generator 40 within gaps 38 between the core 44 and the tubes 42, and all receive a power signal from a power source, such as the power source 18. The core 44 is solid so that air does not flow down the core 44 where there is no plasma field. Therefore, a strong plasma field can be provided in each of the tubes 42 and air can be treated that flows within the tubes 42. In other embodiments, some of the conductors 48 could be within the gaps 38 and some of the conductors 48 could be within the tubes 42

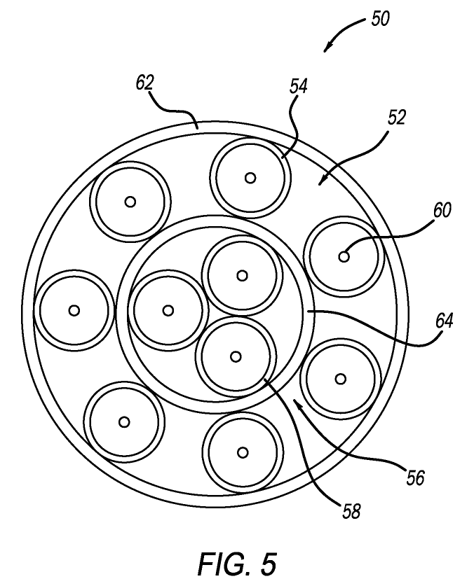

In order to further increase the volume of air that is exposed to the plasma field, alternate designs can include multiple groups of tubes. FIG. 4 is an isometric view and FIG. 5 is an end view of a plasma generator 50 including an outer group 52 of tubes 54, here seven, and an inner group 56 of tubes 58, here three, where the outer group 52 of the tubes 54 is disposed around the inner group 56 of the tubes 58. A conductor 60 extends down each of the tubes 54 and 58. An annular outer conductor 62 is formed outside of, around and in contact with the outer group 52 of the tubes 54 at a center location along the length of the 54, and an annular outer conductor 64 is formed outside of, around and in contact with the inner group 56 of the tubes 58 at a center location along the length of the 54. By providing groups of tubes each with an outer conductor, even more tubes can be employed to clean more air. A power signal from a power source, such as the power source 18, provides power to all of the conductors 60, 62 and 64. Therefore, a strong plasma field can be provided in each of the tubes 54 and 58 and more air can be treated that flows within the tubes 54 and 58.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A plasma generator comprising:
at least one hollow tube being made of a dielectric material;
at least one outer conductor positioned around and in contact with an outer surface of the at least one tube;
at least one inner conductor extending parallel to the at least one tube at a location so that at least some of the dielectric material is between the inner and outer conductors; and
a power source providing a power signal to the at least one inner and outer conductors so as to provide a plasma field within the at least one tube effective to destroy or deactivate contaminants in a gas within the at least one tube.

2. The plasma generator according to claim 1 wherein the at least one inner conductor extends within the at least one tube.

3. The plasma generator according to claim 2 wherein the at least one inner conductor extends down a center location of the at least one tube.

4. The plasma generator according to claim 1 wherein the at least one inner conductor extends outside of the at least one tube.

5. The plasma generator according to claim 1 wherein the at least one tube is a plurality of tubes, the at least one inner conductor is a plurality of inner conductors where a separate inner conductor extends down each tube, and the at least one outer conductor is a single outer conductor wrapped around and in contact with all of the tubes.

6. The plasma generator according to claim 5 wherein the outer conductor is centered along a length of the tubes.

7. The plasma generator according to claim 1 further comprising a solid center cylindrical core, wherein the at least one tube is a plurality of tubes disposed around the center core, the at least one inner conductor is a plurality of inner conductors disposed within gaps between the tubes and the core, and the at least one outer conductor is a single outer conductor wrapped around and in contact with all of the tubes.

8. The plasma generator according to claim 1 wherein the at least one tube is a first group of a plurality of tubes and a second group of a plurality of tubes wrapped around the first group of the tubes, the at least one inner conductor is a plurality of inner conductors where a separate inner conductor extends down each tube, and the at least one outer conductor is a first outer conductor wrapped around all of and in contact with the first group of the tubes and a second outer conductor wrapped around all of and in contact with the second group of the tubes.

9. The plasma generator according to claim 1 wherein the dielectric material is glass.

10. The plasma generator according to claim 1 wherein the at least one tube has a diameter of 8-10 mm.

11. The plasma generator according to claim 1 wherein the power source operates in the 5 kV - 30 kV range.

12. The plasma generator according to claim 1 wherein the power source operates in the 15 kHz – 25 kHz frequency range.

13. A plasma generator comprising:
a solid cylindrical core;
a plurality of tubes disposed around the cylindrical core and being made of a dielectric material;
an outer conductor positioned around and in contact with an outer surface of the plurality of tubes;
a plurality of inner conductors extending parallel to the tubes at a location so that at least some of the dielectric material is between the inner and outer conductors; and
a power source providing a power signal to the inner and outer conductors so as to provide a plasma field within the plurality of tubes effective to destroy or deactivate contaminants in a gas flowing through the tubes.

14. The plasma generator according to claim 13 wherein one of the plurality of inner conductors extends within each tube.

15. The plasma generator according to claim 14 wherein each inner conductor extends down a center location of the tube.

16. The plasma generator according to claim 13 wherein the plurality of inner conductors extend outside of the plurality tubes.

17. The plasma generator according to claim 13 wherein the outer conductor is centered along a length of the tubes.

18. A plasma generator comprising:
a first group of a plurality of tubes each being made of a dielectric material;
a second group of a plurality of tubes wrapped around the first group of the tubes;
a first outer conductor wrapped around all of and in contact with the first group of the tubes and between the first group of the tubes and the second group of the tubes;
a second outer conductor wrapped around all of and in contact with the second group of the tubes;
a plurality of inner conductors where a separate inner conductor extends down each tube; and
a power source providing a power signal to the inner and outer conductors so as to provide a plasma field within the tubes effective to destroy or deactivate contaminants in a gas within the tubes.

19. The plasma generator according to claim 18 wherein each inner conductor extends down a center location of the tube.

20. The plasma generator according to claim 18 wherein the first outer conductor is centered along a length of the first group of tubes and the second outer conductor is centered along a length of the second group of tubes.
